(19) United States
(12) Patent Application Publication
(10) Pub. No.: US 2021/0173498 A1
(43) Pub. Date: Jun. 10, 2021

(54) TOUCH CONTROL SCREEN AND ITS PREPARATION METHOD AS WELL AS TOUCH CONTROL APPARATUS

(71) Applicant: Shenzhen Hitevision Technology Co., Ltd., Shenzhen (CN)

(72) Inventors: Peiqi ZHANG, Shenzhen (CN); Nana REN, Shenzhen (CN); Hui ZHOU, Shenzhen (CN)

(21) Appl. No.: 16/984,723

(22) Filed: Aug. 4, 2020

(30) Foreign Application Priority Data
Dec. 6, 2019 (CN) 201911246707.X

(51) Int. Cl. G06F 3/041

(52) U.S. Cl. CPC G06F 3/041; G02F 1/13338; G06F 2203/04103

(57) ABSTRACT

This application relates to a touch screen and its preparation method as well as touch control apparatus. This application also relates to the field of touch screen lamination. The touch screen provided by the application comprises a display panel, a touch control panel, and a frame disposed between the display panel and the touch control panel; a cavity is formed by the frame together with the display panel and the touch control panel; and the cavity is filled with a non-solid medium. In the touch control screen, non-solid medium is used to replace the existing waterborne adhesive. On the one hand, non-solid medium can reduce gaps during lamination, and achieve a perfect lamination between the touch control panel and the display panel, thereby obtaining better display effect. On the other hand, non-solid medium has much lower cost than waterborne adhesive, thereby significantly reducing production costs.

### CROSS-REFERENCE TO RELATED APPLICATION

This application claims priority to Chinese Patent Application No. 201911246707.X, filed on Dec. 6, 2019, which is hereby incorporated by reference in its entirety.

### TECHNICAL FIELD

This application refers to the field of touch control screen manufacturing, particularly to a touch control screen and its preparation method as well as touch control apparatus.

### BACKGROUND

Touch screen, also referred as “touch control screen”, “touch control panel”, is an inductive liquid crystal display apparatus that can receive input signals such as from contacts. When a graphic button on the screen is touched, the tactile feedback system on the screen can drive various connection devices according to a pre-programmed program, can be used to replace mechanical button panel and produce moving audio and video effects by using liquid crystal display panel. As a newest input device, touch screen is currently the simplest, most convenient and natural way of human-computer interaction.

Existing touch screens are generally made by laminating display panel and touch control panel by full lamination technology. In an existing full lamination technology, adhesives (optical adhesive such as OCA, or waterborne adhesive such as OCR) have been used to fully fill the air layer between display panel and touch control panel, thereby achieving the close lamination between the display panel and the touch control panel, avoiding the pollution from dust and water vapor, maintaining the cleanliness of the screen; reduce the loss of light, and significantly improving the visual effect of the display panel. In addition, the full lamination technology can effectively reduce the interference of noise and improve the smooth feeling of touch control operation.

In the prior art, a way of planer dispensing lamination is generally utilized to fill with the adhesives. A phenomenon of adhesive overflow occurs during the dispensing lamination, resulting in the waste of a large amount of waterborne adhesive. In addition, waterborne adhesives have higher cost, resulting in higher production costs. Meanwhile, the fitness obtained by dispensing lamination is insufficient, resulting in poor display effect of the screen.

### SUMMARY

In view of the above problems, the present application is proposed to provide a touch control screen, a laminating method, and a touch control apparatus that overcome or at least partially overcome the above problems.

An embodiment of the present application provides a touch control screen, comprising a display panel, a touch control panel, and a frame disposed between the display panel and the touch control panel; a cavity is formed by the frame together with the display panel and the touch control panel; and the cavity is filled with a non-solid medium.

Optionally, said non-solid medium satisfies the properties of: a refractive index of 1.3 to 1.8, and a light transmittance ≥90%.

Optionally, said non-solid medium satisfies the properties of: a viscosity <2000 mPa·S, and stable performance at a temperature of −40° C. to 100° C.

Optionally, said non-solid medium has a filling volume V_{non-solid medium} satisfying:

V_{non-solid medium}=V_{cavity}×(1−K)

in which, V_{cavity} represents the volume of the cavity, and K represents the expansion coefficient of the non-solid medium.

Optionally, said frame is prepared by applying frame adhesive according to a preset shape.

Optionally, said frame adhesive comprises an optical adhesive.

Optionally, said cavity has a height of 0.3 to 5 mm.

Based on the same inventive concept, an embodiment of the present application also provides a preparation method of a touch control screen, which is used to prepare the above non-solid full-laminated touch control screen, the method comprising:

according to a preset shape, applying a frame adhesive on a laminating surface of a touch control panel to form a frame, and bonding a laminating surface of a display panel with the frame to form a cavity; or,
according to a preset shape, applying a frame adhesive on a laminating surface of a display panel to form a frame, and bonding a laminating surface of a touch control panel with the frame to form a cavity; or,
according to a preset shape, applying a frame adhesive on a laminating surface of a display panel and a laminating surface of a touch control panel, respectively, to form frames on both the laminating surface of the touch control panel and the laminating surface of the display panel, and bonding the frame on the laminating surface of the touch control panel with the frame on the laminating surface of the display panel to form a cavity; and
injecting a non-solid medium into the cavity to give the touch control screen.

Optionally, said cavity has a reserved injection hole. The step of injecting a non-solid medium into the cavity to give the touch control screen comprises: vacuuming the cavity;

injecting the non-solid medium into the vacuumed cavity through the injection hole; after injecting the non-solid medium, sealing the injection hole to obtain a touch control screen.

Optionally, said preparation method further comprises the steps of reserving an exhaust hole in the cavity, exhausting gases from the cavity filled with a non-solid medium through the exhaust hole, and sealing the exhaust hole, to obtain the touch control screen.

Based on the same inventive concept, an embodiment of the present application further provides a touch control apparatus, characterized in that, the touch control apparatus comprises the non-solid full-laminated touch control screen as described above.

One or more technical solutions in the embodiments of the present application have at least one or more of the following technical effects or advantages.

In the touch control screen provided by an embodiment of the present application, due to use of non-solid medium to replace the existing optical adhesives, especially waterborne adhesives, for use in lamination of touch panel and display panel, on the one hand, the non-solid medium can reduce gaps during lamination and significantly improve the fitness between touch panel and display panel, thereby obtaining better display effect of the touch control screen; on the other hand, non-solid medium has much lower cost than optical/waterborne adhesive, thereby significantly reducing production costs.

Described above is merely an overview of the technical solution of the present invention. In order to better understand the technical means of the present invention so as to implement in accordance with the contents of specification, and in order to more readily understand the above and other objectives, features and advantages of the present invention, specific embodiments of the present invention are provided hereinafter.

### BRIEF DESCRIPTION OF THE DRAWINGS

Upon reading the following detailed description of the embodiments, various advantages and other benefits will become apparent to a person of ordinary skill in the art. The drawings are merely examples for illustrative purposes according to various disclosed embodiments and are not intended to limit the scope of the present disclosure. Further, the same reference numbers will be used throughout the drawings to refer to the same parts. In the drawings:

FIG. 1 is a flowchart 1 of a laminating method for a non-solid full-laminated touch control screen in an embodiment of the present application;

FIG. 2 is a flowchart 2 of a laminating method for a non-solid full-laminated touch control screen in an embodiment of the present application;

FIG. 3 is a flowchart 3 of a laminating method for a non-solid full-laminated touch control screen in an embodiment of the present application;

FIG. 4 is a front view of a non-solid full-laminated touch control screen in Example 1 of the present application;

FIG. 5 is a cross-sectional view of a non-solid full-laminated touch control screen in Example 1 of the present application;

In the drawings: 1 represents an exhaust hole; 2 represents a frame; 3 represents an injection hole; 4 represents a touch panel; 5 represents a display panel; 6 represents a non-solid medium.

### DETAILED DESCRIPTION

The present invention will be described in detail below in conjunction with specific embodiments and examples, and the advantages and various effects of the present invention will be more clearly presented. Those skilled in the art should understand that these specific embodiments and examples are provided for the purpose of illustrating the present invention, rather than limiting the present invention.

Throughout the specification, unless specifically stated otherwise, the terms used herein should be understood as meanings commonly used in the art. Therefore, unless defined otherwise, all technical and scientific terms used herein have the same meaning as those generally understood by those skilled in the art. If, however, there is a contradiction between a definition and/or an interpretation provided in this disclosure and a common knowledge, the definition and the interpretation provided in this present specification shall dominate.

Various raw materials, reagents, instruments and equipment and the like used in the present application are all commercially available or prepared by existing methods, unless otherwise stated.

It should be further noted that the terms of “including”, “comprising” or any other variants thereof intend to encompass a non-exclusive inclusion, such that a process, method, commodity or device comprising a series of elements not only comprises these elements, but also comprises other elements that are not listed, or further comprises elements that are inherent to the process, method, commodity or device.

In the way of planer dispensing lamination in the prior art, waterborne adhesives are generally applied the whole of display panel, followed by laminating touch panel and display panel. Waterborne adhesives need to be cured to become a solid, such that the solid fills between the display panel and the touch panel, so as to meet the use requirements.

As described above, on the one hand, the phenomenon of adhesive overflow occurs during the dispensing lamination results in a waste of a large amount of waterborne adhesive, for the following reasons: waterborne adhesive needs to be completely applied on a display panel and/or a touch panel during the dispensing lamination; and the display panel and touch panel need to be squeezed during the lamination process, which will inevitably cause a large amount of waterborne adhesive to overflow. Thus, this results in a large amount of wasted waterborne adhesive.

On the other hand, in the existing touch control screen, the fitness of lamination with waterborne adhesive between display panel and touch panel is insufficient, resulting in poor display effect, for the following reasons: bubbles will be inevitably generated during the lamination process with waterborne adhesive, and cannot be eliminated in time, so some voids and pores will be generated, thereby resulting in insufficient fitness.

Since bubbles are very easily generated in the existing lamination process with waterborne adhesive, the requirements for the lamination process are extremely high. Currently, manual lamination is generally applied, and automatic production cannot be utilized. In addition, subsequent cleaning of adhesive is required in the existing lamination process with waterborne adhesive. Thus, very high labor cost is required.

In order to solve the above technical problems, the overall concept in the technical solution in embodiments of the present application is outlined as follows.

Referring to FIG. 5, an embodiment of the application provides a touch control screen, comprising a display panel, a touch control panel, and a frame disposed between the display panel and the touch control panel; a cavity is formed by the frame together with the display panel and the touch control panel; and the cavity is filled with a non-solid medium

In the above embodiment, non-solid medium is used to fill the air layer between display panel and touch panel; and the display panel and touch panel are bonded with frame adhesive.

By using non-solid medium, at least the following problems during the lamination process with waterborne adhesive may be solved:

a. generation of bubbles that are inevitably generated during the lamination process with waterborne adhesive, thereby deteriorating the display effect;
b. adhesive overflow that occurs during the full lamination process, thereby resulting in a waste of a large amount of waterborne adhesive, requiring additional cleaning of adhesive, and significantly increasing the production cost;
c. currently, the lamination process with waterborne adhesive is semi-automatic, in order to ensure the full lamination effect, and the production efficiency is low.

As some optional embodiments, said non-solid medium satisfies the properties of: a refractive index of 1.3 to 1.8, and a light transmittance ≥90%.

By using a non-solid medium has a refractive index of 1.3 to 1.8, which is closer to display material than air (air has a refractive index of about 1.0, while a display material has a refractive index of about 1.5), the loss of transmitted light can be significantly reduced and the brightness of the screen can be increased, thereby providing better display effect.

The requirement of light transmittance ≥90% of non-solid medium is for the purpose of increasing the transmittance of transmitted light and increasing screen contrast. As some optional embodiments, said non-solid medium satisfies the properties of: a viscosity <2000 mPa·S, and stable performance at a temperature of −40° C. to 100° C.

The above limitations of the properties of the non-solid medium is given for the purpose of making the non-solid medium fill the cavity better, so as to present a better display effect. Among them, the viscosity requirement of <2000 mPa·S is provided to ensure that the non-solid medium has good fluidity during the filling process, so as to better fill the cavity. The requirement of stable performance at a temperature of −40° C. to 100° C. is provided for the following reasons: a display product generally has a normal working and operating temperature range of −20° C. to +50° C., and the limitation of the thermal stability at a temperature of −40° C. to +100° C. can ensure that good performance can still be maintained in extreme environments.

Stable performance at a temperature of −40° C. to 100° C. includes, but is not limited to, no deformation, no reaction, no change in molecular morphology and the like, at a temperature of −40° C. to 100° C.

As some optional embodiments, said non-solid medium is a medium that does not exist in a solid form, including but not limited to a liquid medium.

As some optional embodiments, said non-solid medium has a filling volume V_{non-solid medium} satisfying:

V_{non-solid medium}=V_{cavity}×(1−K)

in which, V_{cavity} represents the volume of the cavity, and K represents the expansion coefficient of the non-solid medium.

Non-solid medium has thermal expansion properties, wherein its length, area, and volume will increase correspondingly when heated. Its expansion coefficient indicates the degree of expansion when heated. Under a consistent volume of the cavity, the filling volume of non-solid medium will vary with the change of expansion coefficient, and specifically meet the above relationship. Otherwise, the cavity wall will be subjected to an increased stress due to thermal expansion, which will ultimately affect the service life.

As some optional embodiments, said frame is prepared by applying frame adhesive according to a preset shape.

The frame prepared from frame adhesive, on the one hand, can form a cavity with display panel and touch panel, used for filling with non-solid medium without overflow; on the other hand, the display effect will not be influence.

As some optional embodiments, said frame adhesive comprises optical adhesive.

Optical adhesives (adhesives for bonding optical parts) is a type of polymer materials with similar optical performance to optical parts and with excellent bonding performance. An optical adhesive has a light transmittance of in the designated light wave band of greater than 90% or more, and a refractive index after curing that is similar to the refractive index of the adhered optical element, thereby not influencing the display effect. In the embodiments of the present invention, the optical adhesive includes but is not limited to waterborne adhesive.

Waterborne adhesive is a general term for glues or adhesives in which water is used as a solvent or a dispersion medium, and is commonly opposite to a solvent-based adhesive (that is, an adhesive in which an organic solvent is used as a solvent or a dispersion medium). In the embodiments of the present invention, the waterborne adhesive may be selected from a single component and multiple components.

As some optional embodiments, said cavity has a height of 0.3 to 5 mm.

Since display products are used upright, bonding strength and shear strength between display panel and touch panel are the key factors to ensure the normal use of the products. The thickness of the bonding layer (that is, the height of the cavity) is used to provide the desirable bonding strength and shear strength. In embodiments of the present application, in order to meet the requirements of the bonding strength and shear strength during use, the height of the cavity is required to be 0.3 to 5 mm.

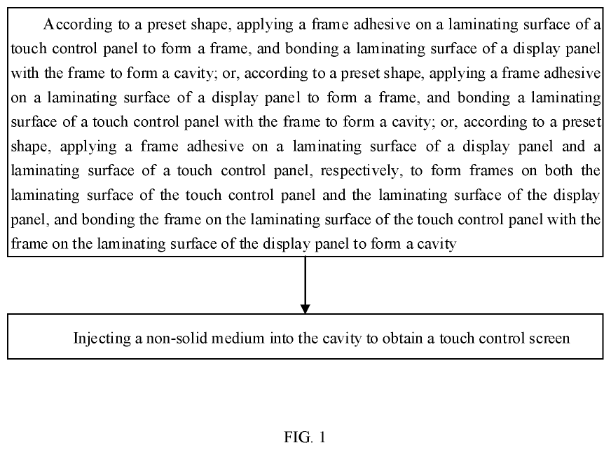

Referring to FIG. 1, based on the same inventive concept, an embodiment of the present application also provides a preparation method of a touch control screen, which is used to prepare the above non-solid full-laminated touch control screen, comprising:

according to a preset shape, applying a frame adhesive on a laminating surface of a touch control panel to form a frame, and bonding a laminating surface of a display panel with the frame to form a cavity; or,
according to a preset shape, applying a frame adhesive on a laminating surface of a display panel to form a frame, and bonding a laminating surface of a touch control panel with the frame to form a cavity; or,
according to a preset shape, applying a frame adhesive on a laminating surface of a display panel and a laminating surface of a touch control panel, respectively, to form frames on both the laminating surface of the touch control panel and the laminating surface of the display panel, and bonding the frame on the laminating surface of the touch control panel with the frame on the laminating surface of the display panel to form a cavity; and injecting a non-solid medium into the cavity to give the touch control screen.

In the prior art, a phenomenon of adhesive overflow occurs during the dispensing lamination, resulting in the waste of a large amount of waterborne adhesive; and automatic production cannot be utilized. In contrast, in the above method provided by an embodiment of the application, adhesive overflow can be avoided, thereby significantly reducing the amount of waterborne adhesive; meanwhile, automatic production is viable. The reasons for viable automatic production are as follows.

As discussed above, since bubbles are very easily generated in the existing lamination process with waterborne adhesive, the requirements for the lamination process are extremely high. As a result, currently, manual lamination is generally applied, and automatic production cannot be utilized. In addition, subsequent cleaning of adhesive is required in the existing lamination process with waterborne adhesive. Thus, very high labor cost is required.

In the non-solid full-lamination method provided by an embodiment of the application, use of water adhesive is merely required at the frame, thereby significantly reducing the amount of water adhesive used and greatly reducing the generation of bubbles. Even if a small amount of bubbles are present, they can be further discharged through the exhaust hole. In addition, most of the bonding layer between display panel and touch panel is replaced by a non-solid medium which has low process requirements without the generation of bubbles. Thus, automatic production is viable.

The above preset shape is generally configured according to the appearance and shape of touch control screen, including but not limited to rectangles having four rectangular corners or four circular arc-like corners, squares, squares having four circular arc-like corners, ellipses, circles and the like.

In embodiments of the present invention, the frame formed by applying adhesive needs to be cured. After curing, display panel and touch panel are bonded and fixed. The method for curing frame adhesive mainly depends on the composition of the adhesive, and includes but is not limited to at least one of the following: heat curing and UV curing.

As compared with the prior lamination method with waterborne adhesive, the non-solid full-lamination method provided by an embodiment of the application has the following beneficial effects:

1. viable automatic lamination of display panel and touch control panel, thus simplifying the manufacturing process;
2. omitting the subsequent cleaning of adhesive, saving the labor, and increasing the efficiency;
3. avoiding the phenomenon of adhesive overflow, and saving the production costs.

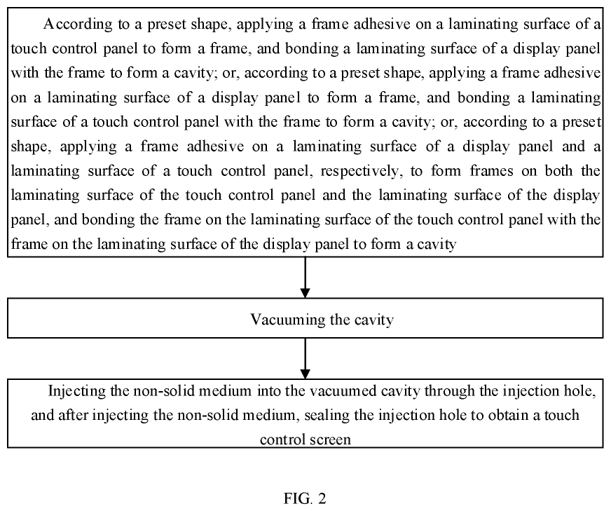

Referring to FIG. 2, as an optional embodiment, said cavity has a reserved injection hole. The step of injecting a non-solid medium into the cavity to give the touch control screen comprises:

vacuuming the cavity;
injecting the non-solid medium into the vacuumed cavity through the injection hole; after injecting the non-solid medium, sealing the injection hole to obtain a touch control screen.

In the vacuum processing, the vacuum pressure is 0.4 to 1 MPa.

Reserving an injection hole in the cavity means reserving an injection hole before the application of adhesive as described above, thereby forming a frame with an injection hole. A cavity with an injection hole is formed after lamination of display panel, touch panel, and the frame with an injection hole.

When the vacuumed cavity of the screen is fully filled with a non-solid medium, the vacuumed cavity is tilted, and the tilt angle is 0 to 60°.

The injection speed is related to the viscosity of the non-solid medium, the volume and profile of the cavity.

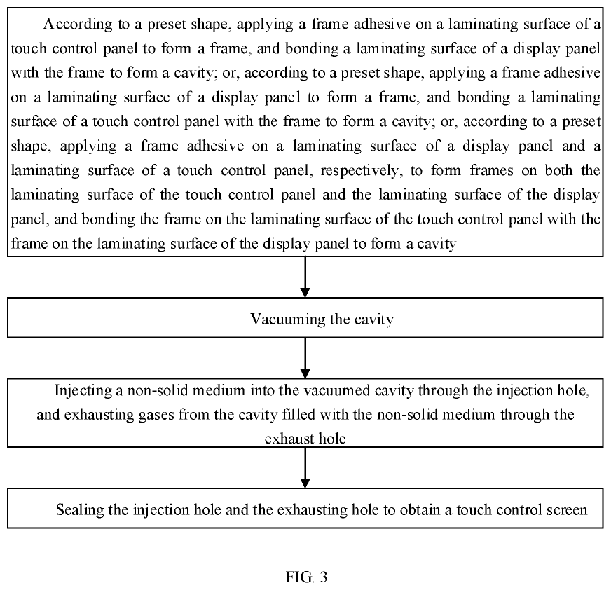

Referring to FIG. 3, as an optional embodiment, the preparation method further comprises the steps of reserving an exhaust hole in the cavity, exhausting gases from the cavity filled with a non-solid medium through the exhaust hole, and then sealing the exhaust hole, to obtain the touch control screen.

Further, reserving an exhaust hole means reserving an exhaust hole before the application of adhesive as described above, thereby forming a frame with an injection hole and an exhaust hole. A cavity with an injection hole and an exhaust hole is formed after lamination of display panel, touch panel, and the frame with an injection hole and an exhaust hole.

In this embodiment, one or more of exhaust holes may be reserved. The amount of exhaust hole generally depends on the amount of gases to be discharged.

In this embodiment, the cavity filled with the non-solid medium includes not only the cavity filled with the non-solid medium, but may also include the frame for the cavity.

Based on the same inventive concept, an embodiment of the present application further provides a touch control apparatus, characterized in that, the touch control apparatus comprises the non-solid full-laminated touch control screen as described above

The touch control screen, the lamination method and the touch control apparatus provided by the embodiments of the present application will be described in detail below in conjunction with the embodiments and experimental data.

### Example 1

This example provided a non-solid full-laminated touch control screen prepared by the following lamination method:

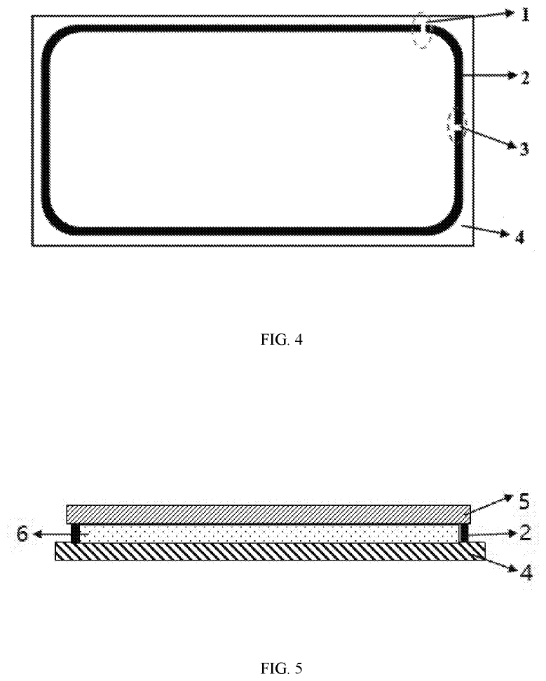

Referring to FIG. 4, in accordance with the rectangle having four circular arc-like corners, a frame adhesive was applied on the laminating surface of touch control panel. During the application, an injection hole was reserved. A frame was formed, and bonded with a laminating surface of display panel. After curing, a cavity was formed. The curing was performed for 120 min at a temperature of 80° C. The cavity had a height of 1 mm.

The cavity was vacuumed under a pressure of 0.4 MPa.

Through the injection hole, a liquid medium was injected into the vacuumed cavity. During the injection, the vacuumed cavity was tilted with the tilt angle of 60°.

Through the exhaust hole, gases in the cavity filled with liquid medium were discharged.

The injection hole and the exhaust hole were sealed to obtain the touch control screen.

Referring to FIG. 5, the touch control screen was prepared in Example 1, comprising a display panel, a touch control panel, and a frame disposed between the display panel and the touch control panel; a cavity was formed by the frame together with the display panel and the touch control panel; and the cavity was filled with a non-solid medium.

In Example 1, the properties of the liquid medium were as follows: in liquid state, having a refractive index of 1.400, a light transmittance of 96%, and a viscosity of 500 mPa·S, and stable performance at a temperature of −40° C. to 100° C.

### Example 2

This example provided a non-solid full-laminated touch control screen prepared by the following lamination method:

In accordance with the rectangle having four circular arc-like corners, a frame adhesive was applied on the laminating surface of display panel. During the application, an injection hole and an exhaust hole were reserved. A frame was formed, and bonded with a laminating surface of touch control panel. After curing, a cavity was formed. The curing was performed for 60 min at a temperature of 150° C. The cavity had a height of 0.8 mm.

The cavity was vacuumed under a pressure of 0.6 MPa.

Through the injection hole, a non-solid medium was injected into the vacuumed cavity. During the injection, the vacuumed cavity was tilted with the tilt angle of 30°.

Through the exhaust hole, gases in the cavity filled with non-solid medium were discharged.

The injection hole and the exhaust hole were sealed to obtain the touch control screen.

The touch control screen was prepared in Example 2, comprising a display panel, a touch control panel, and a frame disposed between the display panel and the touch control panel; a cavity was formed by the frame together with the display panel and the touch control panel; and the cavity was filled with a non-solid medium.

In Example 2, the properties of the non-solid medium were as follows: having a refractive index of 1.4, a light transmittance of 95%, and a viscosity of 1000 mPa·S, and stable performance at a temperature of 40° C. to 100° C.

### Example 3

This example provided a non-solid full-laminated touch control screen prepared by the following lamination method:

In accordance with the rectangle having four circular arc-like corners, a frame adhesive was applied on the laminating surfaces of touch control panel and display panel. During the application, an injection hole and an exhaust hole were reserved. Frames were formed between the laminating surface of touch control panel and the laminating surface of display panel. The frame on the laminating surface of the touch control panel was bonded with the frame on the laminating surface of the display panel. After curing, a cavity was formed. The curing was performed by heating at a rate of 1500 mj/cm² and heating for 60 min at a temperature of 120° C. The cavity had a height of 0.5 mm.

The cavity was vacuumed under a pressure of 0.4 MPa.

Through the injection hole, a non-solid medium was injected into the vacuumed cavity. During the injection, the vacuumed cavity was tilted with the tilt angle of 45°.

Through the exhaust hole, gases in the cavity filled with non-solid medium were discharged.

The injection hole and the exhaust hole were sealed to obtain the touch control screen.

The touch control screen was prepared in Example 3, comprising a display panel, a touch control panel, and a frame disposed between the display panel and the touch control panel; a cavity was formed by the frame together with the display panel and the touch control panel; and the cavity was filled with a non-solid medium.

In Example 3, the properties of the non-solid medium were as follows: having a refractive index of 1.7, a light transmittance of 94%, and a viscosity of 1300 mPa·S, and stable performance at a temperature of −40° C. to 100° C.

### Experimental Example 1

The existing dispensing lamination process was used in Comparative Example 1. The cost of the adhesive layer in the processes for preparing the screens and the display effect of the obtained screens were tested in Examples 1-3 and Comparative Example 1. Test results were shown in Table 1.

TABLE 1

| | Costs of adhesive layer for | Display effect of screen | |
|---|---|---|---|
| | 10,000 screens/RMB | Brightness | Contrast |
| Example 1 | 50,000 | Excellent | Excellent |
| Example 2 | 40,000 | Excellent | Excellent |
| Example 3 | 25,000 | Excellent | Excellent |
| Comparative | 3503,000 | Poor | Poor |
| Example 1 | | | |

As shown in Table 1, the screens prepared by the embodiments of the present application can exhibit a better display effect with significantly reduced costs of the adhesive layer, and thus represent notable technical progress.

While some embodiments of the present invention have been described, additional variations and modifications in those embodiments may occur to those skilled in the art once they learn of the basic inventive concepts. Therefore, it is intended that the appended claims shall be construed to include those embodiments and all such variations and modifications falling within the scope of the invention.

Obviously, those skilled in the art can make various changes and variations on the present disclosure without departing from the spirit and scope of the present disclosure. Thus, the present disclosure intends to cover the changes and variations to the present disclosure if such changes and variations belong to the scope defined by the claims of the present disclosure and equivalence thereof

What is claimed is:

1. A touch control screen, wherein, said touch control screen comprising a display panel, a touch control panel, a frame disposed between the display panel and the touch control panel; a cavity is formed by the frame together with the display panel and the touch control panel; and the cavity is filled with a non-solid medium.

2. The touch control screen according to claim 1, wherein, the non-solid medium satisfies the properties of: a refractive index of 1.3 to 1.8, and a light transmittance ≥90%.

3. The touch control screen according to claim 1, wherein, the non-solid medium satisfies the properties of: a viscosity <2000 mPa·S, and stable performance at a temperature of −40° C. to 100° C.

4. The touch control screen according to claim 1, wherein, said non-solid medium has a filling volume V_{non-solid medium} satisfying:
V_{non-solid medium}=V_{cavity}×(1−K)
in which, V_{cavity} represents the volume of the cavity, and K represents the expansion coefficient of the non-solid medium.

5. The touch control screen according to claim 1, wherein, the frame is prepared by applying frame adhesive according to a preset shape.

6. The touch control screen according to claim 5, wherein, the frame adhesive comprises an optical adhesive.

7. The touch control screen according to claim 1, wherein, said cavity has a height of 0.3 to 5 mm.

8. A preparation method of a touch control screen, which is used to prepare the above non-solid full-laminated touch control screen, the method comprising:
according to a preset shape, applying a frame adhesive on a laminating surface of a touch control panel to form a frame, and bonding a laminating surface of a display panel with the frame to form a cavity; or,
according to a preset shape, applying a frame adhesive on a laminating surface of a display panel to form a frame, and bonding a laminating surface of a touch control panel with the frame to form a cavity; or
according to a preset shape, applying a frame adhesive on a laminating surface of a display panel and a laminating surface of a touch control panel, respectively, to form frames on both the laminating surface of the touch control panel and the laminating surface of the display panel, and bonding the frame on the laminating surface of the touch control panel with the frame on the laminating surface of the display panel to form a cavity; and
injecting a non-solid medium into the cavity to give the touch control screen.

9. The preparation method of a touch control screen according to claim 8, wherein, the preparation method comprising reserving an injection hole in the cavity; the step of injecting a non-solid medium into the cavity to give the touch control screen comprises:
vacuuming the cavity;
injecting the non-solid medium into the vacuumed cavity through the injection hole;
after injecting the non-solid medium, sealing the injection hole to obtain a touch control screen.

10. The preparation method of a touch control screen according to claim 9, wherein, the preparation method further comprising the steps of reserving an exhaust hole in the cavity, exhausting gases from the cavity filled with a non-solid medium through the exhaust hole, and sealing the exhaust hole, to obtain the touch control screen.

11. A touch control apparatus, wherein, the touch control apparatus comprises the touch control screen according to of claim 1.
